(19) United States
(12) Patent Application Publication
(10) Pub. No.: US 2005/0149384 A1
(43) Pub. Date: Jul. 7, 2005

(54) Vehicle parking validation system and method

(76) Inventor: Gilad Odinak, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 10/926,687

(22) Filed: Aug. 26, 2004

Related U.S. Application Data
(63) Continuation of application No. 09/955,476, filed on Sep. 17, 2001, now abandoned.
(60) Provisional application No. 60/280,376, filed on Mar. 29, 2001.
(60) Provisional application No. 60/281,231, filed on Apr. 2, 2001.

(51) Int. Cl. G06F 17/60

(52) U.S. Cl. 705/13

(57) ABSTRACT

A system and method for performing vehicle payment transactions. The system includes a vehicle with a location determining component and a communication component, and a server with a communication component, a vehicle location identifying component, and a transaction completing component. The location determining component determines the location of the vehicle, and the vehicle communication component sends the determined vehicle location information to the server. The server communication component receives the determined vehicle location information from the vehicle. The vehicle location identifying component determines if the sent vehicle location locates the vehicle in a pay location. If the vehicle location identifying component determines that the vehicle is located in a pay location, the transaction completing component completes a payment transaction.

### PRIORITY CLAIM

This application is a continuation of U.S. patent application Ser. No. 09/955,476 filed Sep. 17, 2001, which application claims priority from U.S. Provisional Application Ser. No. 60/280,376, filed Mar. 29, 2001, Attorney Docket No. WING-1-1004 and Ser. No. 60/281,231, filed Apr. 2, 2001, Attorney Docket No. WING-1-1008.

### FIELD OF THE INVENTION

This invention relates generally to the field of wireless communication, digital commerce and vehicle parking.

### BACKGROUND OF THE INVENTION

There exist a few locations where a vehicle owner must make a payment based on the location of the owner's vehicle. For example, the owner must make a payment in order to use a toll road or bridge or to park in a pay parking location. Many times when the owner parks in a pay parking location they forget to pay or pay an incorrect amount based on the parking rate that varies depending upon the time and day of the week. When the owner fails to properly remit payment, they can be assessed hefty penalties. Therefore, there exists a need to allow a vehicle owner to easily and accurately pay the required amount when using a toll-based facility or for parking.

### SUMMARY OF THE INVENTION

A system and method for performing vehicle parking transactions is provided. The system includes a vehicle having a location determining component and a communication component, and a server having a communication component, a vehicle location identifying component, and a transaction completing component. The location determining component determines the location of the vehicle, and the vehicle communication component sends the determined vehicle location information to the server. The server communication component receives the determined vehicle location information from the vehicle. The vehicle location identifying component determines if the sent vehicle location locates the vehicle in a pay location, and the transaction completing component completes a payment transaction, if the vehicle location identifying component determines that the vehicle is located at a pay location.

In accordance with further aspects of the invention, the communication components are configured to communicate over a wireless data channel via a network.

In accordance with other aspects of the invention, the pay location is a parking location and the transaction completing component includes a paying component. The paying component pays an owner associated with the parking location where the vehicle is located from an account associated with the owner of the vehicle.

In accordance with still further aspects of the invention, the transaction completing component notifies an attendant at the parking location that is associated with the vehicle location that payment has been completed.

In accordance with yet other aspects of the invention, the communication component of the vehicle sends the determined vehicle location after a first vehicle trigger event occurs. The first vehicle trigger event includes one of shutting off the engine, removing the vehicle key from the ignition switch, opening or closing the vehicle door, or locking the vehicle. The server begins a clock after the determined vehicle location is received and stops the clock after a second trigger event. The second vehicle trigger event includes one of unlocking the door, inserting the key in the ignition switch, opening or closing the vehicle door, starting the vehicle, or moving the vehicle a threshold distance from the vehicle's previous location.

As will be readily appreciated from the foregoing, the invention provides a method and system for billing a vehicle owner when the owner's vehicle is in a pay location, such as a traditional parking lot or other on- or off-street parking location, a toll bridge, or toll road.

### BRIEF DESCRIPTION OF THE DRAWINGS

The preferred and alternative embodiments of the present invention are described in detail below with reference to the following drawings.

FIG. 1 is a block diagram illustrating the general architecture of a vehicle parking validation system that operates in accordance with the present invention;

FIG. 2 is a flow chart illustrating the operation of one embodiment of the present invention wherein the parking fee is automatically calculated and assessed; and

FIG. 3 is a flow chart illustrating the operation of one embodiment of the present invention wherein a parking attendant is involved in validating parking.

### DETAILED DESCRIPTION OF THE PREFERRED EMBODIMENT

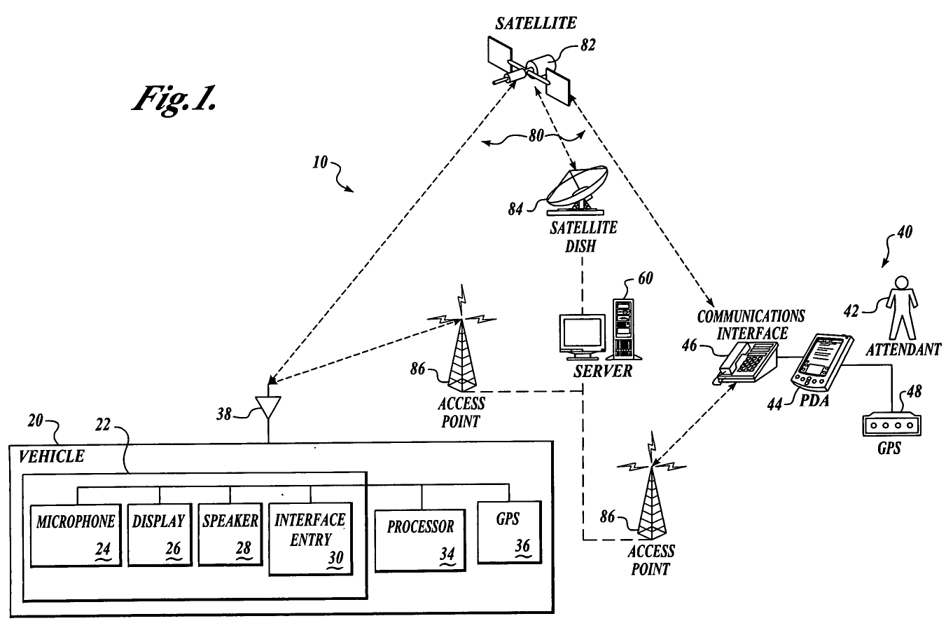

The present invention provides a system and method for validating vehicle parking that uses a global positioning system (GPS) to confirm the location of a vehicle with respect to a pay parking location. FIG. 1 shows one embodiment of a vehicle validation system 10 of the present invention wherein a parking attendant is involved in validating parking. The vehicle validation system includes a vehicle 20 and an attendant system 40 in wireless data communication with a server 60 via a wireless data channel 80. Both vehicle 20 and attendant system 40 are used to wirelessly locate and authorize payment for vehicle parking at a specified parking location.

More specifically, FIG. 1 illustrates the particular components of the embodiment of system 10. In the preferred embodiment, vehicle 20, typically controlled by a human operator, includes a user interface 22 having a microphone 24 for capturing the user's voice; a display 26; speakers 28; and an interface entry 30 for allowing the user to perform various interactive functions. The vehicle further includes a voice processor 34 for performing sound processing of the user's voice; a GPS 36 for determining precise vehicle location; and a wireless communications device 38, such as a cellular modem, for transmitting and receiving wireless information.

Attendant system 40 includes an attendant 42, which may be an automated attendant but in the preferred embodiment is a human operator; an attendant operation device 44, in the preferred embodiment a portable, hand-held unit; a communications interface 46, in the preferred embodiment integral with operation device 44, for transmitting and receiving wireless information; and a GPS 48 for determining precise attendant system location.

Both vehicle 20 and attendant system 40 are in communication with server 60. The server houses vehicle and attendant system information. Vehicle information may include, for example, the identity and credit authorization information on the vehicle user, as well as technical information on the vehicle, such as make, model and license. The server may also maintain historical and current location information for the vehicle. Attendant system information may include, for example, the identity, location and parking capacity of the parking location associated with the attendant system. The server also processes and responds to requests for information from the vehicle and attendant system; such requests may include location verification and vehicle parking payment confirmation. In an alternative embodiment, the server may communicate information obtained from information sources (not shown) to either the vehicle or attendant system. The information sources store information subject to requests from the vehicle. These information sources may be integral with or independent from server 60. If independent from server 60, the server communicates with information sources via direct access (e.g., hard-wired or point-to-point connection) as well as over the Internet. In the preferred embodiment, the server includes a processor, a memory, and a database (not shown). Server 60 further includes a means for sending and receiving information to both the vehicle and the attendant system, discussed below.

Wireless data channel 80 facilitates communication of instructions and information among vehicle 20, attendant system 40, and server 60. In a preferred embodiment, the wireless data channel may include a satellite system 82 in combination with a satellite dish 84, along with or in the place of one or more access points 86, the latter as part of a cellular or other wireless transmission network. In operation, instructions are transmitted from vehicle 20 via communication device 38 or attendant system 40 via communications interface 46 to either the satellite system or access point, which in turn communicate the instructions to server 60, in the former case via satellite dish 84. Conversely, information may be communicated from the server to the vehicle along a reverse direction of the same route.

In an alternative embodiment of the present invention, the parking fee is automatically calculated and assessed directly via the vehicle interface. In this embodiment, FIG. 1 would be modified to remove attendant system 40 and its related components.

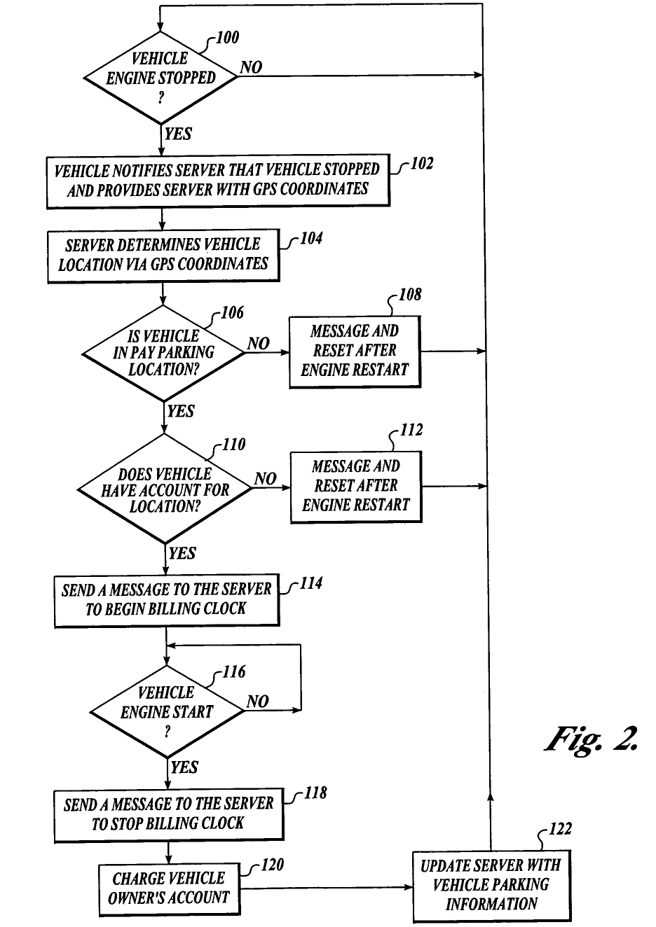

A first embodiment of the system and method of the present invention is better understood with reference to FIG. 2, which illustrates the operational steps of the vehicle validation system and method. No attendant system is used in this embodiment. Rather, vehicle validation is tied to the vehicle location as determined by the GPS, electronic payment authorization of the vehicle, and known information on pay parking locations. At decision block 100, a determination is made whether the vehicle engine stops. This occurrence constitutes a trigger event that initiates the subsequent operation of the present invention in this embodiment. The trigger events could be any number of occurrences, for example, removing the key from the ignition, opening or closing the vehicle door, the vehicle user engaging a pay parking location initiation indicator, etc. If the trigger condition is not met, the system proceeds in a continuous loop back to block 100. If the trigger condition is met, the logic proceeds to block 102, where the vehicle notifies the server that the trigger condition is met and parking information is requested. Preferably this notice to the server includes the vehicle's GPS coordinates. At block 104, the server determines the vehicle location via the GPS coordinates.

At decision block 106, the determination is made, based on the GPS location information, whether the vehicle is in a pay parking location, or a parking location incorporated into the network of the present invention. This is accomplished by the server accessing database records relative to the identification, location and account information associated with the vehicle. If the vehicle is not in a pay parking location, the logic proceeds to block 108, where the server sends a message to the vehicle, perhaps with a recommendation to a pay parking location. The system then resets, in the preferred embodiment based on the vehicle engine startup, and returns in operational logic to block 100. If the vehicle is in a pay parking location, the logic proceeds to decision block 110, where it is determined whether the vehicle has made payment arrangements for parking in the pay parking location. If no payment arrangements have been made, the logic proceeds to block 112, where the server sends a message to the vehicle notifying the vehicle that it does not have an account for the pay parking location. The notification message may also include information on how to set up an account for the pay parking location, or a recommendation as to a different pay parking location. The system then resets, in the preferred embodiment based on vehicle engine startup, and returns in operational logic to block 100. In an alternative embodiment, the system may allow the vehicle to provide electronic payment authorization information at that stage.

If the vehicle has made payment arrangements for the pay parking location, the logic proceeds to block 114, where the vehicle sends a message to the server to start the billing clock. At decision block 116, the system enters a holding pattern based on a determination whether the vehicle engine is started, which would signify an end to the billing cycle for the particular pay parking location. As noted above, there may be various trigger events that initiate the logic sequence at this point in the invention. If the vehicle engine has not started, the system proceeds in a continuous loop back to block 116. If the vehicle engine starts, the logic proceeds to block 118, where the vehicle sends a message to the server to stop the billing clock. At block 120, the server calculates the amount owed for parking and charges the vehicle owner's account. At block 122, the server is updated with vehicle parking information.

In an alternative embodiment of the above-described operational logic, the server automatically monitors both vehicle location and vehicle engine status. When the server detects that the vehicle engine has stopped, it immediately ascertains the vehicle location, based on GPS coordinates. If the server determines that the vehicle engine stopped in a pay parking location, it automatically starts the billing clock. Once the server determines that the vehicle engine is started again, it stops the billing clock. In this embodiment, as described above, the server determines account information and charges the vehicle owner's account accordingly.

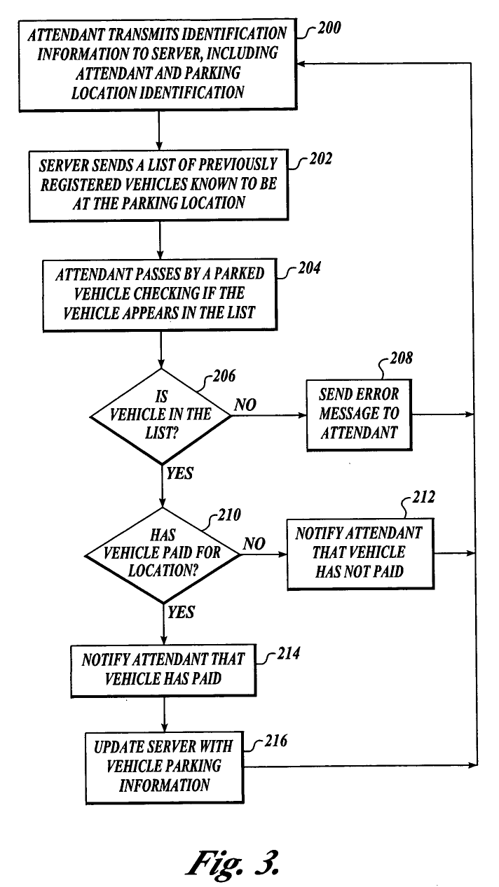

An alternative embodiment of the system and method of the present invention, as used with described attendant system 40, is better understood with reference to FIG. 3. At block 200, the attendant system transmits identification information to server 60, including attendant system and parking location identification information. Alternatively, the server may already have in its database some or all of this information, in which case this step involves refreshing and/or confirming the accuracy and timeliness of the information. At block 202, the server sends a list of previously registered vehicles to the attendant's system. The list includes vehicles known to be parking at the attendant's parking location or within a threshold proximity distance from the attendant (e.g. within 50 feet). At block 204, the attendant passes by a parked vehicle and checks that the vehicle appears on the sent list by reference to vehicle identification, for example, the vehicle license plate or VIN. In an alternative embodiment, the vehicle may also include a location-specific mark, such as a sticker or tag, which identifies the vehicle as being registered with the above-described parking location system.

At decision block 206, the attendant system automatically or the attendant manually makes a determination whether the vehicle is on the list or registered in the system. If the vehicle is not on the list, the vehicle is a legacy vehicle and the logic proceeds to block 208, where the attendant receives a message, perhaps with a recommendation as to course of action. A legacy vehicle is one not registered by the above described parking system and must be dealt with by prior parking procedures. If the vehicle is on the list, the logic proceeds to block 210. At decision block 210, the determination is made whether the vehicle has previously paid for or authorized electronic payment for parking at the pay parking location. The server accesses database records to make this determination. In an alternative embodiment, the attendant makes the payment authorization determination directly. If the vehicle has not made such payment arrangements, the logic proceeds to block 212, where the server notifies the attendant system that the vehicle has not paid. The attendant system may then secure payment from the vehicle by other means. In an alternative embodiment, the server may also request electronic payment for the requested parking, providing it has appropriate authorization for the vehicle account. If the vehicle has made necessary pay arrangements, the logic proceeds to block 214, where the server notifies the attendant system that the vehicle has paid, or made arrangements to pay for parking in the pay parking location. At block 216, the server is updated with vehicle parking information.

While the preferred embodiment of the invention has been illustrated and described, as noted above, many changes can be made without departing from the spirit and scope of the invention. For example, the order in which determinations are made as to whether the vehicle is in a pay parking location and whether the vehicle has made pay arrangements could be changed. In addition, there may exist variations on when the billing clock is started and stopped, what trigger events are used, and how and when the parking charges are calculated and electronically assessed. Accordingly, the scope of the invention is not limited by the disclosure of the preferred embodiment.

1. A computer-based vehicle payment method comprising:
determining vehicle location of a vehicle;
sending the determined vehicle location to a server;
determining at the server whether the sent vehicle location locates the vehicle in a pay location; and
if it is determined that the vehicle is located in a pay location, completing a payment transaction.

2. The method of claim 1, wherein sending of the determined vehicle location is wirelessly transmitted over a data channel to the server via a network.

3. The method of claim 1, wherein completing the payment transaction comprises paying an owner associated with the pay location from an account associated with the vehicle.

4. The method of claim 3, wherein completing the payment transaction further comprises notifying an attendant at the pay location that payment has been completed.

5. The method of claim 3, wherein payment is performed automatically.

6. The method of claim 1, wherein sending occurs after a first vehicle trigger event occurs.

7. The method of claim 6, wherein the first vehicle trigger event comprises at least one of shutting off the engine, removing the vehicle key from the ignition switch, opening or closing the vehicle door, or locking the vehicle.

8. The method of claim 6, wherein the server begins a clock after the determined vehicle location is received.

9. The method of claim 8, further comprising:
generating a complete transaction signal at the vehicle based on a second trigger event; and
sending the generated complete transaction signal to the server, wherein completing the payment transaction comprises:
stopping the clock after the server receives the complete transaction signal from the vehicle; and
determining an amount of payment required based on an elapsed time of the clock.

10. The method of claim 9, wherein the second vehicle trigger event comprises at least one of unlocking the door, inserting the key in the ignition switch, opening or closing the vehicle door, starting the vehicle, or moving the vehicle a threshold distance from the vehicle's previous location.

11. A computer-based vehicle payment system comprising:
a means for determining vehicle location of a vehicle;
a means for sending the determined vehicle location to a server;
a means for determining at the server whether the sent vehicle location locates the vehicle in a pay location; and
if it is determined that the vehicle is located in a pay location, a means for completing a payment transaction.

12. The system of claim 11, wherein the means for sending transmits the determined vehicle location to the server by wirelessly transmitting the determined vehicle location over a data channel via a network.

13. The system of claim 11, wherein the means for completing the payment transaction comprises a means for paying an owner associated with the pay location from an account associated with the vehicle.

14. The system of claim 13, wherein the means for completing the payment transaction further comprises a means for notifying an attendant at the pay location that payment has been completed.

15. The system of claim 13, wherein the means for completing a payment transaction performs the payment automatically.

16. The system of claim 11, wherein the means for sending transmits the determined vehicle location after a first vehicle trigger event occurs.

17. The system of claim 16, wherein the first vehicle trigger event comprises at least one of shutting off the engine, removing the vehicle key from the ignition switch, opening or closing the vehicle door, or locking the vehicle.

18. The system of claim 16, wherein the server begins a clock after the determined vehicle location is received.

19. The system of claim 18, further comprising:
a means for generating a complete transaction signal at the vehicle based on a second trigger event; and
a means for sending the generated complete transaction signal to the server, wherein the means for completing the payment transaction comprises:
a means for stopping the clock after the server receives the complete transaction signal from the vehicle; and
a means for determining an amount of payment required based on an elapsed time of the clock.

20. The system of claim 19, wherein the second vehicle trigger event comprises at least one of unlocking the door, inserting the key in the ignition switch, opening or closing the vehicle door, starting the vehicle, or moving the vehicle a threshold distance from the vehicle's previous location.

21. A computer-based vehicle payment system comprising:
a vehicle comprising:
a location determining component configured to determine the location of the vehicle; and
a communication component configured to send the determined vehicle location information; and
a server comprising:
a communication component configured to receive the determined vehicle location information from the vehicle;
a vehicle location identifying component configured to determine if the sent vehicle location information locates the vehicle in a pay location; and
a transaction completing component configured to complete a payment transaction if the vehicle location identifying component determines that the vehicle is located in a pay location.

22. The system of claim 21, wherein the communication components are configured to communicate over a wireless data channel via a network.

23. The system of claim 21, wherein the transaction completing component comprises a paying component configured to pay an owner associated with the pay location from an account associated with the vehicle.

24. The system of claim 23, wherein the transaction completing component is further configured to notify an attendant at the pay location that payment has been completed.

25. The system of claim 23, wherein the transaction completing component performs payment automatically.

26. The system of claim 21, wherein the communication component of the vehicle is configured to send the determined vehicle location after a first vehicle trigger event occurs.

27. The system of claim 26, wherein the first vehicle trigger event comprises at least one of shutting off the engine, removing the vehicle key from the ignition switch, opening or closing the vehicle door, or locking the vehicle.

28. The system of claim 26, wherein the server begins a clock after the determined vehicle location is received.

29. The system of claim 28, wherein the vehicle further comprises a complete transaction component configured to generate a complete transaction signal based on a second trigger event, wherein the communication component of the vehicle is further configured to send the generated complete transaction signal to the server, wherein the transaction completing component is further configured to stop the clock after the server receives the complete transaction signal from the vehicle, and to determine an amount of payment required based on elapsed time of the clock.

30. The system of claim 29, wherein the second vehicle trigger event comprises at least one of unlocking the door, inserting the key in the ignition switch, opening or closing the vehicle door, starting the vehicle, or moving the vehicle a threshold distance from the vehicle's previous location.
